(19) United States
(12) Patent Application Publication
(10) Pub. No.: US 2020/0118727 A1
(43) Pub. Date: Apr. 16, 2020

(54) REACTOR

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi (JP)

(72) Inventors: Kazuhiro Inaba, Yokkaichi, Mie (JP); Kouhei Yoshikawa, Yokkaichi, Mie (JP); Akinori Ooishi, Yokkaichi, Mie (JP)

(21) Appl. No.: 16/482,077

(22) PCT Filed: Jan. 22, 2018
(86) PCT No.: PCT/JP2018/001834

§ 371 Date: Jul. 30, 2019

(30) Foreign Application Priority Data
Feb. 10, 2017 (JP) 2017-022864

(51) Int. Cl. H01F 27/24; H01F 27/28

(52) U.S. Cl. CPC H01F 27/24; H01F 27/2823

(57) ABSTRACT

A reactor includes: a coil including a first winding portion and a second winding portion that are formed by winding a wire, the winding portions being disposed side by side; and a magnetic core including a first inner core portion that is disposed on an inner side of the first winding portion, a second inner core portion that is disposed on an inner side of the second winding portion, and outer core portions that are disposed on an outer side of the two winding portions and connect end portions of the two inner core portions. In the coil, a circumferential length of the second winding portion is shorter than a circumferential length of the first winding portion, and the reactor includes a heat dissipation plate that is disposed on at least a portion of an outer circumferential surface of the second winding portion.

### CROSS-REFERENCE TO RELATED APPLICATIONS

This application is the U.S. national stage of PCT/JP2018/001834 filed on Jan. 22, 2018, which claims priority of Japanese Patent Application No. JP 2017-022864 filed on Feb. 10, 2017, the contents of which are incorporated herein.

### TECHNICAL FIELD

The present disclosure relates to a reactor.

### BACKGROUND

A reactor is a component of a circuit that performs a voltage step-up operation and a voltage step-down operation. For example, Patent Documents 1 and 2 disclose a reactor that includes a coil and a magnetic core in which the coil is disposed. JP 2014-146656A discloses a reactor that includes: a coil including a pair or coil elements (winding portions); and an annular magnetic core including a pair of inner core portions that are disposed on the inner side of the coil elements and an outer core portion that is disposed on the outer side of the coil elements and connects the end portions of the inner core portions. According to JP 2014-146656A, the two coil elements have the same number of windings and the same shape, and are disposed side by side and in parallel such that the axial directions of the coil elements are parallel to each other. JP 2009-147041A discloses a reactor in which a heat dissipation member (heat dissipation plate) is provided on an attachment surface of a coil (the attachment surface being an upper surface opposite to an installation surface).

With a reactor as described above that includes: a coil including two winding portions; and an annular magnetic core that is disposed on the inner side and the outer side of the coil (the winding portions), it is desired that heat dissipationability of the coil is ensured while also achieving reduction in the size of the reactor.

In a state in which the reactor is installed, the cooling performance of a cooling mechanism included in an installation object in which the reactor is installed may vary between locations (the cooling performance is not uniform), and one of the winding portions may be cooled sufficiently by the cooling mechanism, but the other winding portion may not be cooled sufficiently.

In a conventional reactor, the wire or two winding portions that constitute the coil have the same specifications, or in other words, the same shape, dimensions, and the like, and thus the two winding portions have the same width and height (outer diameter), and also have an equal circumferential length. That is, the two winding portions of the coil have the same outer dimensions (size). As used herein, the width of each winding portion refers to the length of a winding portion in an arrangement direction in which the two winding portions are provided, and the height of each winding portion refers to the length of a winding portion in a direction perpendicular to the axial direction of the winding portion and the arrangement direction of the two winding portions. Also, the circumferential length of each winding portion refers to the length of the outer circumference (contour line) of the winding portion when the winding portion is viewed in the axial direction, and is substantially equal to the length of one turn. Accordingly, the two winding portions have substantially the same heat generation characteristics, and thus the amount of heat generated by the two winding portions when the coil is energized is equal.

In the conventional reactor, in an installation state as described above in which the other winding portion is not sufficiently cooled, the temperature of the other winding portion becomes higher than that of the one winding portion, which may cause an increase in reactor loss, or the like. In the case of a configuration as disclosed in JP 2009-147041A in which a heat dissipation member is provided on the upper surface of the coil (the two winding portions), the overall height of the coil including the heat dissipation member increases, which increases the size of the reactor, and an issue may occur where, for example, the reactor cannot be installed in the installation space. Accordingly, with the conventional reactor, it has been difficult to achieve both heat dissipationability and size reduction.

Accordingly, it is an object of the present disclosure to provide a reactor that can achieve size reduction while ensuring heat dissipationability of the coil.

### SUMMARY DISCLOSURE

A reactor according to the present disclosure includes: a coil including a first winding portion and a second winding portion that are formed by winding a wire, the winding portions being disposed side by side; and a magnetic core including a first inner core portion that is disposed on an inner side of the first winding portion, a second inner core portion that is disposed on an inner side of the second winding portion, and outer core portions that are disposed on an outer side of the two winding portions and connect end portions of the two inner core portions. In the coil, a circumferential length of the second winding portion is shorter than a circumferential length of the first winding portion, and the reactor includes a heat dissipation plate that is disposed on at least a portion of an outer circumferential surface of the second winding portion.

### Advantageous Effects of Disclosure

With the reactor according to the present disclosure, the size of the reactor can be reduced while ensuring heat dissipationability of the coil.

### BRIEF DESCRIPTION OF DRAWINGS

FIG. 1 is a schematic perspective view of a reactor according to Embodiment 1.

FIG. 2 is a schematic exploded perspective view of the reactor according to Embodiment 1.

FIG. 3 is a schematic perspective view of a coil included in the reactor according to Embodiment 1.

FIG. 4 is a schematic side view of the coil included in the reactor according to Embodiment 1.

FIG. 5 is a schematic front view of the coil and a magnetic core included in the reactor according to Embodiment 1.

FIG. 6 is a diagram showing another example of a heat dissipation plate included in the reactor according to Embodiment 1.

### DETAILED DESCRIPTION OF PREFERRED EMBODIMENTS

The inventors of the present disclosure considered a reactor that includes a coil including two winding portions, wherein the two winding portions are configured to have different circumferential lengths such that the circumferential length of one of the two winding portions is shorter than that of the other winding portion, and a heat dissipation plate is disposed on the outer circumferential surface of the winding portion having a shorter circumferential length. Then, they found that the problem described above can be solved by, when the reactor is installed in an installation object whose cooling performance is not uniform, installing the reactor such that one of the two winding portions is disposed on the side where the cooling performance is high and the other winding portion is disposed on the side where the cooling performance is low. First, embodiments of the disclosure of the present application will be listed and described.

A reactor according to an embodiment of the disclosure of the present application includes: a coil including a first winding portion and a second winding portion that are formed by winding a wire, the winding portions being disposed side by side; and a magnetic core including a first inner core portion that is disposed on an inner side of the first winding portion, a second inner core portion that is disposed on an inner side of the second winding portion, and outer core portions that are disposed on an outer side of the two winding portions and connect end portions of the two inner core portions. In the coil, a circumferential length of the second winding portion is shorter than a circumferential length of the first winding portion, and the reactor includes a heat dissipation plate that is disposed on at least a portion of an outer circumferential surface of the second winding portion.

With the reactor described above, the circumferential length of the second winding portion is shorter than that of the first winding portion, and thus copper loss is smaller in the second winding portion than in the first winding portion, and the amount of heat generated by the second winding portion when the coil is energized is small. The reason being that, when the first winding portion and the second winding portion are formed using the same wire and have the same number of windings, the wire length of the second winding portion that has a shorter circumferential length is shorter than that of the first winding portion, and thus the copper loss is reduced. Furthermore, as a result of a heat dissipation plate being disposed on at least a portion of the outer circumferential surface of the second winding portion, heat dissipationability of the second winding portion can be increased. Here, because the second winding portion has a shorter circumferential length, the width or height (outer diameter) of the second winding portion is smaller than that of the first winding portion, and the outer dimensions (size) of the second winding portion are small. Specifically, in the coil, at least one of the width and the height of the second winding portion is smaller than that of the first winding portion, and both the width and the height of the second winding portion are less than or equal to those of the first winding portion. Accordingly, the size of the second winding portion is reduced as compared with that of the first winding portion, and thus the reduced area can be used as the installation space for installing the heat dissipation plate. For this reason, even when the heat dissipation plate is disposed on the outer circumferential surface of the second winding portion, the overall size of the coil including the heat dissipation plate does not increase, and thus the size of the reactor can be reduced as compared with a conventional coil whose winding portions have the same circumferential length.

When the reactor is installed in an installation object whose cooling performance is not uniform, the reactor is installed such that the first winding portion is disposed on the side where the cooling performance is high, and the second winding portion is disposed on the side where the cooling performance is low. In this case, the amount of heat generated by the first winding portion is relatively large, and thus the temperature is likely to increase, but the first winding portion is sufficiently cooled by the installation object. On the other hand, the second winding portion is not sufficiently cooled by the installation object, but the amount of heat it generates is relatively small, and heat dissipation can be ensured with the heat dissipation plate. Accordingly, an increase in the temperature of the coil (the two winding portions) is suppressed, and reactor loss can be reduced. Thus, the reactor described above can be reduced in size while ensuring heat dissipationability of the coil, and both heat dissipationability and size reduction can be achieved.

As an embodiment of the reactor, in the coil, a height of the second winding portion may be smaller than a height of the first winding portion, and a height difference may be formed between the first winding portion and the second winding portion, and the heat dissipation plate may be disposed on a surface of the outer circumferential surface of the second winding portion where the height difference is formed.

Because the height of the second winding portion is smaller than that of the first winding portion, a height difference is formed between the first winding portion and the second winding portion, and the height difference can be used as the installation space for installing the heat dissipation plate. Also, the heat dissipation plate can be positioned using the height difference when the heat dissipation plate is disposed on the outer circumferential surface of the second winding portion. Because the heat dissipation plate is disposed on a surface of the outer circumferential surface of the second winding portion where the height difference is formed, the overall height of the coil including the heat dissipation plate can be suppressed while ensuring heat dissipationability of the coil, and the height of the reactor can be reduced.

As an embodiment of the reactor, a height difference portion that corresponds to the height difference of the coil may be formed in the outer core portions, and the heat dissipation plate may be sized to extend to the height difference portion of the outer core portions.

Because a height difference portion that corresponds to the height difference of the coil is formed in the outer core portions, and the heat dissipation plate extends to the height difference portion of the outer core portions, heat dissipationability of the outer core portions can be increased. Accordingly, heat dissipation of the outer core portions can be ensured with the heat dissipation plate, and the heat from the magnetic core can be dissipated from the outer core portions via the heat dissipation plate. Thus, heat dissipationability of the magnetic core can also be ensured, and thus an increase in the temperature of the magnetic core is suppressed, and reactor loss can be further reduced. Because the heat dissipation plate is disposed at the height difference portion of the outer core portions, the height of each outer core portion including the heat dissipation plate can be suppressed, and the height of the reactor can be reduced. Accordingly, in the reactor, both heat dissipationability and size reduction can be achieved.

As an embodiment of the reactor, the heat dissipation plate may include a fin.

Because a fin is provided in the heat dissipation plate, heat dissipationability is improved, and heat dissipationability of the coil can be further ensured.

### DETAILED DESCRIPTION OF EMBODIMENTS OF THE DISCLOSURE

A specific example of a reactor according to an embodiment of the disclosure of the present application will be described below with reference to the drawings. In the drawings, the same reference numerals indicate components having the same names. Note that the disclosure of the present application is not limited to the example given below, and the scope of the disclosure of the present application is indicated by the appended claims, and all changes that come within the meaning and range of equivalency of the claims are intended to be embraced within the scope of the disclosure of the present application.

### Embodiment 1

### Configuration of Reactor

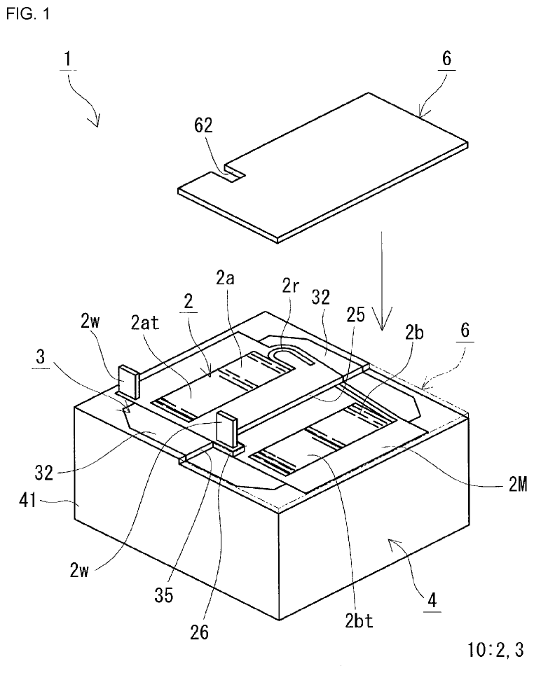

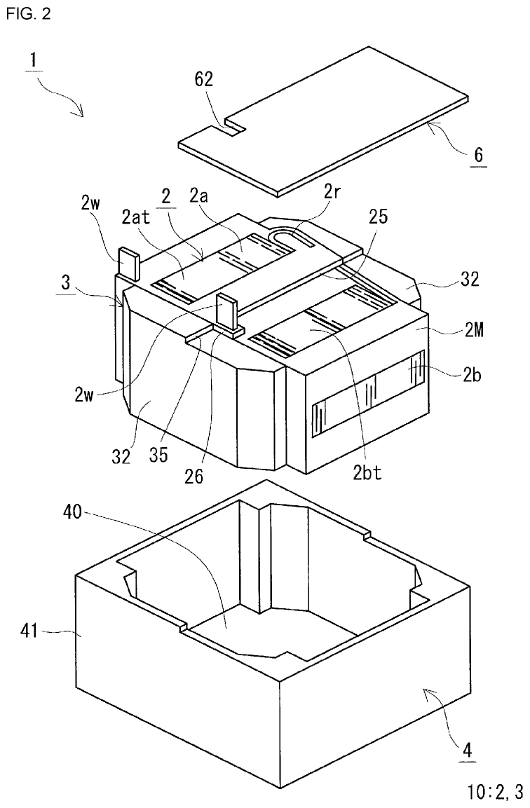

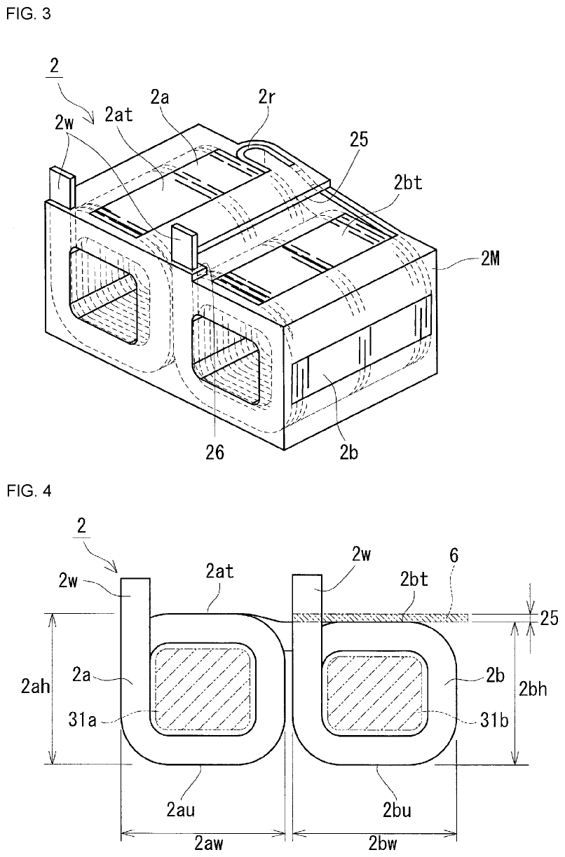

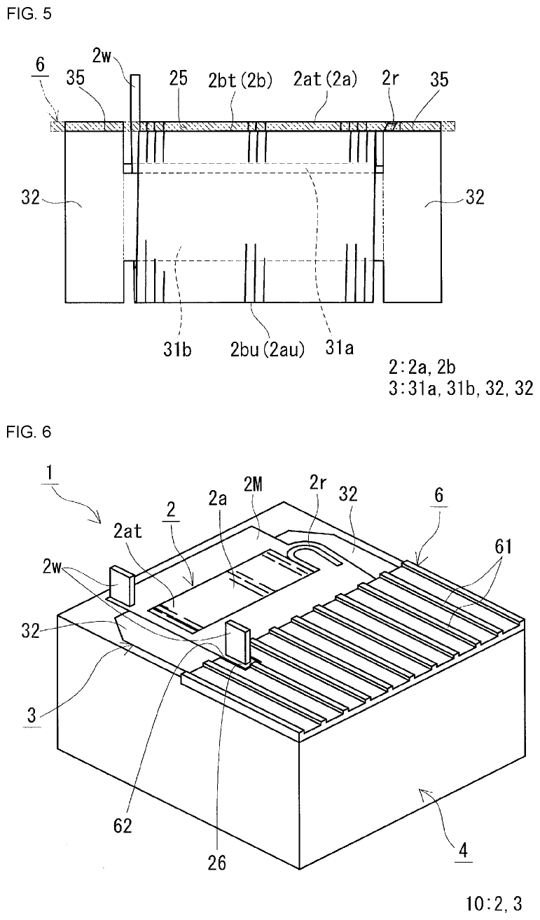

A reactor 1 according to Embodiment 1 and a coil 2 included in the reactor 1 will be described with reference to FIGS. 1 to 5. The reactor 1 according to Embodiment 1 includes: the coil 2 (see FIG. 3) that includes a first winding portion 2a and a second winding portion 2b (hereinafter, may also be collectively referred to as “winding portions 2a and 2b”) that are formed by winding a wire 2w; and a magnetic core 3 that is disposed on the inner side and the outer side of the coil 2 (the winding portions 2a and 2b) (see FIGS. 2, 4, and 5). The first winding portion 2a and the second winding portion 2b are disposed side by side. As shown in FIGS. 4 and 5, the magnetic core 3 includes: a first inner core portion 31a and a second inner core portion 31b (hereinafter, they may be collectively referred to as “inner core portions 31a and 31b”) that are respectively disposed on the inner side of the first winding portion 2a and the second winding portion 2b; and outer core portions 32 that are disposed on the outer side of the winding portions 2a and 2b and connect the end portions of the inner core portions 31a and 31b to each other. As shown in FIG. 4, a feature of the reactor 1 lies in that the coil 2 is configured such that the circumferential length of the second winding portion 2b is shorter than that of the first winding portion 2a, and the reactor 1 includes a heat dissipation plate 6 that is disposed on at least a portion of the outer circumferential surface of the second winding portion 2b (see FIG. 1).

In this example, as shown in FIGS. 1 and 2, the reactor 1 includes a case 4 that houses an assembly 10 that includes the coil 2 and the magnetic core 3.

The reactor 1 is installed in, for example, an installation object (not shown) such as a converter case. Here, in the reactor 1 (the coil 2 and the magnetic core 3), the lower side of FIGS. 1 and 2 is the installation side when the reactor 1 is installed. The installation side will be referred to as “lower” side, and the side opposite to the installation side will be referred to as “upper” side. The up-down direction is defined as the height direction. Also, the arrangement direction of the winding portions 2a and 2b in the coil 2 (the left-right direction in FIG. 4) is defined as the width direction, and the direction extending along the axial directions of the winding portions 2a and 2b (the left-right direction in FIG. 5) is defined as the length direction. The height direction is the same as the direction perpendicular to the axial direction (length direction) of the winding portions 2a and 2b and the arrangement direction (width direction) of the winding portions 2a and 2b. Hereinafter, the constituent elements of the reactor 1 will be described in detail.

### Coil

As shown in FIGS. 3 to 5, the coil 2 includes the first winding portion 2a and the second winding portion 2b that are formed by spirally winding the wire 2w, and the winding portions 2a and 2b are disposed side by side (in parallel) such that the axial directions of the winding portions 2a and 2b are parallel to each other. The winding portions 2a and 2b are formed using the same the wire 2w, and have the same number of windings. In this example, as shown in FIG. 3, the coil 2 (the winding portions 2a and 2b) is formed using one continuous wire 2w, with one end of the wire 2w that forms the winding portion 2a and one end of the wire 2w that forms the winding portion 2b being connected to each other via a connection portion 2r. The other end of the wire 2w that forms the winding portion 2a and the other end of the wire 2w that forms the winding portion 2b are respectively drawn out from the winding portions 2a and 2b in an appropriate direction (upward in this example), and are electrically connected to an external apparatus (not shown) such as a power source, with terminal fittings (not shown) being respectively attached to the other ends as appropriate. The winding portions 2a and 2b may be formed separately by spirally winding the wire 2w, and in this case, one end of the wire 2w that forms the winding portion 2a and one end of the wire 2w that forms the winding portion 2b may be bonded to each other through pressure bonding, welding, or the like.

The wire 2w is, for example, a coated wire (so-called enameled wire) that includes a conductor (copper or the like) and an insulation coating (polyamide imide or the like) on the outer circumferential surface of the conductor. In this example, as shown in FIGS. 3 and 4, the coil 2 (the winding portions 2a and 2b) is an edgewise coil in which the wire 2w, which is a coated flat rectangular wire, is edgewise wound, and the corners of the outer circumferential shape of the end face of each of the winding portions 2a and 2b are round when viewed from the axial direction. There is no particular limitation on the outer circumferential shape of the end face of each of the winding portions 2a and 2b, and the outer circumferential shape may be, for example, a circular shape, an elliptic shape, a racetrack shape (a rounded rectangular shape), or the like.

As shown in FIG. 4, the outer circumferential surfaces of the first winding portion 2a and the second winding portion 2b include lower surfaces 2au and 2bu that are located on the installation side (in other words, the lower side) and upper surfaces 2at and 2bt that are located opposite to the lower surfaces 2au and 2bu. In this example, the lower surface 2au of the first winding portion 2a and the lower surface 2bu of the second winding portion 2b are flush with each other.

In this example, as shown in FIG. 3, the coil 2 is at least partially molded with a resin, and includes a resin molded portion 2M that covers at least a portion of the surface of the coil 2 (the winding portions 2a and 2b). The resin molded portion 2M is formed so as to entirely cover, out of the surface of the coil 2, the inner circumferential surface and both end faces of each of the winding portions 2a and 2b, and also cover a portion of the outer circumferential surface of each of the winding portions 2a and 2b. Here, of the outer circumferential surfaces of the winding portions 2a and 2b, the upper surfaces 2at and 2bt, the lower surfaces 2au and 2bu, and the outer side surfaces located opposite to the opposing inner side surfaces of the winding portions 2a and 2b are exposed. The resin molded portion 2M can prevent the inner circumferential surfaces and the end faces of the winding portions 2a and 2b from coming into contact with the outer circumferential surfaces of the inner core portions 31a and 31b and the inner end faces of the outer core portions 32 (faces opposing the end faces of the winding portions 2a and 2b), and thus the electrical insulation between the coil 2 and the magnetic core 3 (the inner core portions 31a and 31b and the outer core portions 32) can be increased. The resin molded portion 2M is made of an insulating resin, and examples of the insulating resin that can be used as the material for forming the resin molded portion 2M include: thermosetting resins such as an epoxy resin, an unsaturated polyester resin, a urethane resin, and a silicone resin; and thermoplastic resins such as a polyphenylene sulfide (PPS) resin, a polytetrafluoroethylene (PTFE) resin, a liquid crystal polymer (LCP), polyamide (PA) resins including nylon 6 and nylon 66, a polybutylene terphthalate (PBT) resin, and an acrylonitrile-butadiene-styrene (ABS) resin. In FIGS. 4 and 5, the illustration of the resin molded portion 2M is omitted.

In the present embodiment, the winding portions 2a and 2b have different circumferential lengths: the circumferential length of the second winding portion 2b is shorter than the circumferential length of the first winding portion 2a. Specifically, at least one of the width and the height of the second winding portion 2b is smaller than that of the first winding portion 2a, and the width and the height of the second winding portion 2b are less than or equal to those of the first winding portion 2a. Accordingly, the outer dimensions (size) of the second winding portion 2b are smaller than those of the first winding portion 2a. The circumferential length of the winding portions 2a and 2b refers to the length of the outer circumference (contour line) of the winding portions 2a and 2b when viewed from the axial direction (see FIG. 4). Because the circumferential length of the second winding portion 2b is shorter than that of the first winding portion 2a, the copper loss is smaller in the second winding portion 2b than in the first winding portion 2a, and the amount of heat generated when the coil 2 is energized is small.

In this example, as shown in FIG. 4, a width 2aw of the first winding portion 2a and a width 2bw of the second winding portion 2b are substantially the same (2aw=2bw), but the winding portions 2a and 2b have different heights (the height being the length from the lower surface to the upper surface), a height 2bh of the second winding portion 2b being smaller than a height 2ah of the first winding portion 2a (2ah>2bh). Accordingly, the upper surface 2at of the first winding portion 2a and the upper surface 2bt of the second winding portion 2b are not flush with each other, the upper surface 2bt of the second winding portion 2b is lower than the upper surface 2at of the first winding portion 2a, and a height difference 25 is formed between the first winding portion 2a and the second winding portion 2b. The winding portions 2a and 2b have substantially the same length (see FIG. 5). The height difference 25 is used as an installation space where the heat dissipation plate 6, which will be described later, is disposed in the second winding portion 2b (see FIG. 1).

As a result of the circumferential length of the second winding portion 2b being shorter than that of the first winding portion 2a, the size of the second winding portion is smaller than that of the first winding portion, and thus the installation space for installing the heat dissipation plate 6 can be secured accordingly. In this example, as shown in FIG. 4, as a result of the height of the second winding portion 2b being smaller than that of the first winding portion 2a, a height difference 25 is formed, and the height difference 25 is used as the installation space for installing the heat dissipation plate 6. The size of the height difference 25 (the difference in height between the winding portions 2a and 2b (2ah-2bh)) can be set as appropriate according to the thickness of the heat dissipation plate 6, and is a height corresponding to the thickness of the heat dissipation plate 6. The height difference 25 is preferably, for example, 0.2 mm or more and 2 mm or less, and more preferably 0.5 mm or more and 1.5 mm or less. If the difference in circumferential length between the winding portions 2a and 2b is too small, or in other words, if the height difference 25 is too small, it is difficult to secure a sufficient installation space for installing the heat dissipation plate 6. On the other hand, if the difference in circumferential length between the winding portions 2a and 2b is too large, or in other words, if the height difference 25 is too large, the size of the second winding portion 2b is much smaller than that of the first winding portion 2a, and thus the cross-sectional area (magnetic path area) of the second inner core portion 31b is reduced as compared with that of the first inner core portion 31a, which will be described later, and it is difficult to secure a sufficient magnetic path area.

### Heat Dissipation Plate

The heat dissipation plate 6 is disposed on at least a portion of the outer circumferential surface of the second winding portion 2b. In this example, as shown in FIGS. 1, 4, and 5, in the outer circumferential surface of the second winding portion 2b, the heat dissipation plate 6 is disposed on the upper surface 2bt where the height difference 25 is formed. The heat dissipation plate 6 has the function of ensuring heat dissipation of the second winding portion 2b. There is no particular limitation on the size (area) of the heat dissipation plate 6, but the heat dissipationability improves the more the area increases, and for heat dissipation, the more contact area between the second winding portion 2b and the heat dissipation plate 6 is increased, the more advantageous it is. In this example, as shown in FIG. 1, the heat dissipation plate 6 is sized to cover the upper surface 2bt of the second winding portion 2b (excluding the end portion of the wire 2w drawn out from the second winding portion 2b). There is no particular limitation on the thickness of the heat dissipation plate 6, but in order to ensure sufficient heat dissipation of the second winding portion 2b and to fit the heat dissipation plate 6 within the height difference 25 that is the installation space, the thickness of the heat dissipation plate 6 is preferably, for example, 0.2 mm or more and 2 mm or less, and more preferably 0.5 mm or more and 1.5 mm or less. In this example, as shown in FIGS. 4 and 5, the height of the height difference 25 is the same as the thickness of the heat dissipation plate 6, and thus the upper surface of the heat dissipation plate 6 and the upper surface 2at of the first winding portion 2a are flush with each other.

The heat dissipation plate 6 is made of a material that has excellent thermal conductivity (for example, a thermal conductivity of 100 W/(m·K) or more), and in this example, the heat dissipation plate 6 is an aluminum plate. Examples of materials that can be used to form the heat dissipation plate 6 include: metal materials such as aluminum, an alloy thereof, magnesium, an alloy thereof, copper, an alloy thereof, silver, an alloy thereof, iron, steel, and austenitic stainless steel; ceramic materials such as aluminum nitride and silicon carbide; and composite materials composed of a metal and a ceramic (MMC: Metal Matrix Composites) such as Al—SiC and Mg—SiC.

It is preferable that the heat dissipation plate 6 includes a positioning portion for positioning relative to the second winding portion 2b. In this example, as shown in FIG. 1, in the heat dissipation plate 6, a cutout 62 that functions as the positioning portion is formed at a position corresponding to the end portion of the wire 2w of the second winding portion 2b. Also, in the resin molded portion 2M, a protruding portion 26 is formed so as to surround the end portion of the wire 2w of the second winding portion 2b. The heat dissipation plate 6 is positioned relative to the second winding portion 2b as a result of the cutout 62 of the heat dissipation plate 6 being engaged with the protruding portion 26 of the resin molded portion 2M.

The heat dissipation plate 6 is fixed so as to come into contact with at least a portion of the outer circumferential surface of the second winding portion 2b. The heat dissipation plate 6 can be fixed using, for example, an adhesive. A grease may be applied to the contact surface between the heat dissipation plate 6 and the second winding portion 2b. In doing so, the adhesion between the heat dissipation plate 6 and the second winding portion 2b can be increased. As shown in FIG. 1, in the case where the heat dissipation plate 6 has a size (area) extending to a side wall portion 41 of the case 4, the heat dissipation plate 6 may be fixed to the side wall portion 41 of the case 4 using a screw or the like.

### Magnetic Core

As shown in FIGS. 2, 4, and 5, the magnetic core 3 includes a first inner core portion 31a disposed on the inner side of the first winding portion 2a and a second inner core portion 31b disposed on the inner side of the second winding portion 2b (see FIG. 4), and also includes a pair of outer core portions 32 respectively disposed on the outer side of the winding portions 2a and 2b (see FIGS. 2 and 5). The inner core portions 31a and 31b are portions that are respectively located on the inner side of the winding portions 2a and 2b, and are portions where the coil 2 is disposed. That is, as with the winding portions 2a and 2b, the inner core portions 31a and 31b are disposed side by side (in parallel) such that the axial directions of the inner core portions 31a and 31b are parallel to each other. Here, the arrangement direction of the inner core portions 31a and 31b matches the width direction, and the axial directions of the inner core portions 31a and 31b match the length direction. The inner core portions 31a and 31b may be configured such that a portion of each end portion thereof in the axis direction protrudes from the winding portions 2a and 2b. The outer core portions 32 are portions that are located on the outer side of the winding portions 2a and 2b and are portions where the coil 2 is not substantially disposed (or in other words, portions that protrude from the winding portions 2a and 2b (are exposed)). The magnetic core 3 is configured to have an annular shape such that the outer core portions 32 are provided on the end portions of the inner core portions 31a and 31b so as to connect the end portions of the inner core portions 31a and 31b. When the coil 2 is energized, a magnetic flux flows through the magnetic core 3, and a closed magnetic path is thereby formed.

The first inner core portion 31a and the second inner core portion 31b may be shaped so as to respectively correspond to, for example, the inner circumferential surfaces of the winding portions 2a and 2b. In this example, as shown in FIG. 4, the cross section perpendicular to the axial direction of each of the first inner core portion 31a and the second inner core portion 31b has a rectangular shape. Here, as described above, the circumferential length of the second winding portion 2b is shorter than that of the first winding portion 2a, and the size of the second winding portion 2b is smaller than that of the first winding portion 2a, and thus the inner core portions 31a and 31b have different cross sectional areas, and the cross sectional area of the second inner core portion 31b is smaller than that of the first inner core portion 31a. Specifically, the inner core portions 31a and 31b have substantially the same width, but the inner core portions 31a and 31b have different heights, and the height of the second inner core portion 31b is smaller than that of the first inner core portion 31a. In this example, the lower surfaces of the inner core portions 31a and 31b are flush with each other, but the upper surfaces of the inner core portions 31a and 31b are not flush with each other, and the upper surface of the second inner core portion 31b is lower than the upper surface of the first inner core portion 31a. In the example shown in FIG. 4, an example has been described in which the inner core portions 31a and 31b have different cross sectional areas, but the cross sectional area of the first inner core portion 31a may be the same as that of the second inner core portion 31b. In this case, the gap (the thickness of the resin molded portion 2M) between the inner circumferential surface of the first winding portion 2a and the outer circumferential surface of the first inner core portion 31a increases.

There is no particular limitation on the shape of the outer core portions 32, but in this example, as shown in FIG. 2, the outer core portions 32 have a trapezoidal planar shape when viewed from the height direction, with the bottom surface serving as the inner end face that is connected to the end faces of the inner core portions 31a and 31b. The outer core portions 32 protrude in the up-down direction with respect to the inner core portions 31a and 31b (see FIG. 4), and the lower surface and the upper surface of each outer core portion 32 protrude from the lower surface and upper surface of the inner core portion 31a or 31b (see FIG. 5 also). The lower surfaces of the outer core portions 32 are flush with the lower surface of the coil 2 (the lower surfaces 2au and 2bu of the winding portions 2a and 2b). In this example, as shown in FIGS. 2 and 5, each outer core portion 32 has different heights on the first winding portion 2a side (the left side in FIG. 2) and the second winding portion 2b side (the right side in FIG. 2), and a height difference portion 35 that corresponds to the height difference 25 of the coil 2 is formed in the outer core portions 32. Specifically, the upper surface on the second winding portion 2b side is lower than the upper surface on the first winding portion 2a side, and the height difference portion 35 is formed in the upper surface of the outer core portions 32. The upper surface of the outer core portions 32 on the first winding portion 2a side and the upper surface of the outer core portions 32 on the second winding portion 2b side are respectively flush with the upper surfaces 2at and 2bt of the winding portions 2a and 2b. The size of the height difference portion 35 corresponds to that of the height difference 25 of the coil 2, and is the same as the thickness of the heat dissipation plate 6 (preferably, for example, 0.2 mm or more and 2 mm or less, and more preferably 0.5 mm or more and 1.5 mm or less). In this example, as shown in FIG. 5, the heat dissipation plate 6 has a size (area) extending to the height difference portion 35 of the outer core portions 32, and the heat dissipation plate 6 is also disposed in the height difference portion 35. The height difference portion 35 is used as an installation space where the heat dissipation plate 6 is disposed in the outer core portions 32 (see FIG. 1).

The magnetic core 3 (the inner core portions 31a and 31b and the outer core portions 32) is made of a material containing a soft magnetic material. Examples of the material for forming the magnetic core 3 include a soft magnetic powder made of iron or an iron-based alloy (Fe—Si alloy, Fe—Si—Al alloy, Fe—Ni alloy, or the like), a powder compact formed by compacting a coated soft magnetic powder having an insulation coating or the like, a molded body of a composite material containing a soft magnetic powder and a resin, a stacked body in which soft magnetic plates such as electromagnetic steel plates are stacked, a sintered material such as a ferrite core, and the like. As the resin contained in the composite material, a thermosetting resin, a thermoplastic resin, a room temperature-curable resin, a low temperature-curable resin, or the like can be used. Examples of the thermoplastic resin include a polyphenylene sulfide (PPS) resin, a polytetrafluoroethylene (PTFE) resin, a liquid crystal polymer (LCP), a polyamide (PA) resin, a polybutylene terphthalate (PBT) resin, an acrylonitrile-butadiene-styrene (ABS) resin, and the like. Examples of the thermosetting resin include an unsaturated polyester resin, an epoxy resin, a urethane resin, a silicone resin, and the like. Other examples that can be used include a BMC (Bulk Molding Compound) obtained by mixing calcium carbonate or glass fibers with an unsaturated polyester, a millable silicone rubber, a millable urethane rubber, and the like.

In the powder compact, the content of soft magnetic powder can be increased as compared with that in the molded body of a composite material. For example, the content of soft magnetic powder in the powder compact is preferably more than 80 vol %, and more preferably 85 vol % or more. The content of soft magnetic powder in the composite material is preferably 30 vol % or more 80 vol % or less, and more preferably 50 vol % or more 75 vol % or less. In the case where the soft magnetic powders are made of the same material, the saturated magnetic flux density can be increased by increasing the content of the soft magnetic powder. Also, in general, pure iron tends to have a saturated magnetic flux density higher than that of an iron-based alloy. Accordingly, when pure iron is used, the saturated magnetic flux density is likely to increase.

In this example, the magnetic core 3 is formed of a molded body of a composite material. Specifically, the magnetic core 3 is formed by filling the case 4 (see FIG. 2) in which the coil 2 (see FIG. 3) is housed with a composite material containing an unsolidified resin and then solidifying the resin to mold the composite material into a unitary body. At this time, the winding portions 2a and 2b are filled with the composite material, and the inner core portions 31a and 31b are formed. In this case, the inner core portions 31a and 31b and the outer core portions 32 are integrally formed by the molded body of the composite material. A gap may be formed in the inner core portions 31a and 31b. The gap may be an air gap, or may be formed by a gap material. As the gap material, for example, a plate made of a nonmagnetic material, for example, a ceramic such as alumina or a resin such as an epoxy resin (including a fiber-reinforced plastic such as glass epoxy) can be used.

In this example, the case 4 is used as a die for molding the magnetic core 3, and the magnetic core 3 is integrally molded using a composite material, but the configuration is not limited thereto. The magnetic core 3 may be composed of a plurality of core pieces that are formed separately. For example, a configuration may be used in which the magnetic core 3 is divided into inner core portions 31a and 31b and outer core portions 32, and the inner core portions 31a and 31b and the outer core portions 32 are formed using separate core pieces. In this case, the core pieces that constitute the inner core portions 31a and 31b and the outer core portions 32 may be made of the same material, or may be made of different materials. Alternatively, the core pieces that constitute the inner core portions 31a and 31b and the outer core portions 32 may be made of the same material, but the specifications may be different such as the material and the amount of soft magnetic powder. Specifically, for example, the inner core portions 31a and 31b may be formed using core pieces formed of a powder compact, and the outer core portions 32 may be formed using core pieces formed of a molded body of a composite material, or the inner core portions 31a and 31b may be formed using core pieces formed of a molded body of a composite material, and the outer core portions 32 may be formed using core pieces formed of a powder compact. Alternatively, one of the inner core portions 31a and 31b may be formed using a core piece formed of a powder compact, and the other inner core portion may be formed using a core piece formed of a molded body of a composite material. In the case where the magnetic core 3 is formed using a plurality of core pieces, the core pieces may be integrally bonded using, for example, an adhesive. Also, the inner core portions 31a and 31b may be formed using a plurality of core pieces. In this case, a gap may be formed between the core pieces. The number of gaps and the thickness of each gap can be set as appropriate such that desired magnetic characteristics can be obtained.

As shown in FIG. 4, in the case where the cross sectional area (magnetic path area) of the second inner core portion 31b is smaller than that of the first inner core portion 31a, when the inner core portions 31a and 31b are made of the same material, the second inner core portion 31b is more likely to undergo magnetic saturation than the first inner core portion 31a. Accordingly, it is preferable that the saturated magnetic flux density of the second inner core portion 31b is larger than that of the first inner core portion 31a. In this case, the magnetic saturation of the second inner core portion 31b can be suppressed, and loss caused by the magnetic saturation can be reduced. For example, the first inner core portion 31a may be formed using a molded body of a composite material, and the second inner core portion 31b may be formed using a powder compact. Alternatively, the specifications of the second inner core portion 31b may be different from those of the first inner core portion 31a such that the second inner core portion 31b is made using a material having a saturated magnetic flux density higher than that of material of the first inner core portion 31a.

### Case

As shown in FIGS. 1 and 2, the case 4 houses the assembly 10 that includes the coil 2 and the magnetic core 3. In this example, as shown in FIG. 2, the case 4 has a rectangular box shape, and includes a bottom plate portion 40 and a rectangular frame-shaped side wall portion 41 extending upright from the bottom plate portion 40. The inner circumferential surface of the side wall portion 41 is shaped so as to correspond to the outer circumferential surface of the assembly 10. The lower surface and outer circumferential surface of each outer core portion 32, and the lower surface and the outer side surface of the coil 2 (the winding portions 2a and 2b) are in contact with the inner surface (the bottom plate portion 40 and the side wall portion 41) of the case 4. The case 4 is made of a metal, and is capable of absorbing heat from the coil 2 and the magnetic core 3 (the outer core portions 32) and efficiently dissipating the heat to the outside. Examples of materials that can be used to form the case 4 include aluminum, an alloy thereof, magnesium, an alloy thereof, copper, an alloy thereof, silver, an alloy thereof, iron, steel, austenitic stainless steel, and the like.

In this example, the heat dissipation plate 6 has a size (area) extending to the side wall portion 41 of the case 4 (see FIG. 1), and the upper end portion of the side wall portion 41 is partially cut out so that the heat dissipation plate 6 can be disposed thereon. Specifically, in the side wall portion 41, a cut-out is made in the upper end portion on the second winding portion 2b side (the right side in FIG. 2), and a height difference is formed in the upper surface of the case 4.

### Advantageous Effects

The reactor 1 according to Embodiment 1 produces the following advantageous effects.

Because the circumferential length of the second winding portion 2b is shorter than that of the first winding portion 2a, the amount of heat generated by the second winding portion 2b is small. Furthermore, because the heat dissipation plate 6 is disposed on the outer circumferential surface of the second winding portion 2b, the heat dissipationability of the second winding portion 2b can be increased. Because the circumferential length of the second winding portion 2b is shorter than that of the first winding portion 2a, the size of the second winding portion 2b is reduced, and thus the reduced area can be used as the installation space for installing the heat dissipation plate 6. For this reason, even when the heat dissipation plate 6 is disposed on the outer circumferential surface of the second winding portion 2b, the overall size of the coil 2 including the heat dissipation plate 6 does not increase, and thus the overall size can be reduced. When the reactor 1 as described above is installed in an installation object whose cooling performance is not uniform, the reactor 1 is installed such that the first winding portion 2a is disposed on the side where the cooling performance is high, and the second winding portion 2b is disposed on the side where the cooling performance is low. In this case, the second winding portion 2b is not sufficiently cooled by the installation object as compared with the first winding portion 2a, but the amount of heat generated is small, and heat dissipation can be ensured by the heat dissipation plate 6. Thus, an increase in the temperature of the second winding portion 2b is suppressed, and a loss can be reduced. Accordingly, with the reactor 1, heat dissipationability of the coil 2 can be ensured, and both heat dissipationability and size reduction can be achieved.

According to Embodiment 1, the height of the second winding portion 2b is smaller than that of the first winding portion 2a, and a height difference 25 is formed between the first winding portion 2a and the second winding portion 2b, and the height difference 25 can be used as the installation space for installing the heat dissipation plate 6. Also, out of the outer circumferential surface of the second winding portion 2b, the heat dissipation plate 6 is disposed on the surface where the height difference 25 is formed (in this example, the upper surface 2bt), and thus the overall height of the coil 2 including the heat dissipation plate 6 can be suppressed while ensuring the heat dissipation of the second winding portion 2b.

According to Embodiment 1, a height difference portion 35 corresponding to the height difference 25 of the coil 2 is formed in each outer core portion 32, and the heat dissipation plate 6 extends to the height difference portion 35 of the outer core portions 32. With this configuration, heat dissipation of the outer core portions 32 can also be ensured by the heat dissipation plate 6. Thus, an increase in the temperature of the magnetic core 3 is suppressed, and a loss can be further reduced. Also, the heat dissipation plate 6 is disposed on the height difference portion 35 of the outer core portions 32, and thus the height of each outer core portion 32 including the heat dissipation plate 6 can be suppressed. Accordingly, with the reactor 1, heat dissipationability of the magnetic core 3 can also be ensured, and both heat dissipationability and size reduction can be achieved. Furthermore, as shown in FIGS. 1 and 2, in the case where the heat dissipation plate 6 extends to the side wall portion 41 of the case 4, heat absorbed from the coil 2 and the magnetic core 3 (the outer core portions 32) can be efficiently transferred to the case 4 via the heat dissipation plate 6, and thus heat dissipationability is improved. In this case, there is no local protruding portion on the surface of the case 4 other than the end portions of the wire 2w, and the outer surface of the case can be a flat surface without a height difference. Accordingly, other members are unlikely to catch on the surface of the case 4 during attachment of the reactor 1 to an installation object.

### Applications

The reactor 1 according to Embodiment 1 is suitable for use as, for example, a component that constitutes a vehicle-mounted converter (typically a DC-DC converter) mounted on a vehicle such as a hybrid automobile, a plug-in hybrid automobile, an electric automobile, or a fuel cell automobile, a component of various types of converters such as a converter of an air conditioner, or a component of a power converting apparatus.

### Variations

At least one of the following changes and additions may be made to the reactor 1 according to Embodiment 1 described above.

In the reactor 1 according to Embodiment 1, as shown in FIG. 6, the heat dissipation plate 6 may include a fin 61. In the heat dissipation plate 6 shown in FIG. 6, a plurality of fins 61 are provided on its upper surface, and due to the fins 61, the surface area increases, and heat dissipation can be efficiently performed, and thus heat dissipationability is improved.

The reactor 1 according to Embodiment 1 described above is configured such that the heat dissipation plate 6 is a flat plate, and is disposed only on the upper surface 2bt of the second winding portion 2b. However, the configuration is not limited thereto. The heat dissipation plate 6 may be elongated such that the heat dissipation plate 6 is also disposed on the upper surface 2at of the first winding portion 2a. For example, the heat dissipation plate 6 may be sized so as to cover not only the upper surface 2bt of the second winding portion 2b but also the upper surface 2at of the first winding portion 2a, and the thickness of the heat dissipation plate 6 on the first winding portion 2a side may be made smaller than the thickness of the heat dissipation plate 6 on the second winding portion 2b side by an amount corresponding to the height difference 25. In this case, the thickness of the heat dissipation plate 6 on the first winding portion 2a side is thinner than the thickness of the heat dissipation plate 6 on the second winding portion 2b side, and thus the overall height of the coil 2 including the heat dissipation plate 6 does not become excessively large. Because the thickness of the heat dissipation plate 6 on the first winding portion 2a side is smaller than the thickness of the heat dissipation plate 6 on the second winding portion 2b side, heat dissipationability decreases, but with the heat dissipation plate 6, the heat dissipation of the first winding portion 2a can also be ensured. In this case, the heat dissipation plate 6 may be further elongated such that the heat dissipation plate 6 is disposed not only on the height difference portion 35 of the outer core portions 32 (the upper surface on the second winding portion 2b side), but also on the upper surface on the first winding portion 2a side.

The reactor 1 according to Embodiment 1 described above is configured such that the winding portions 2a and 2b have different heights, the upper surfaces 2at and 2bt of the winding portions 2a and 2b are not flush with each other, and the height difference 25 is formed on the upper surface side of the coil 2. However, the configuration is not limited thereto. The height difference 25 may be formed on the lower surface side of the coil 2. For example, the height difference 25 can be formed on the lower surface side of the coil 2 by shifting the position of the lower surface 2bu of the second winding portion 2b in the height direction such that the lower surface 2bu of the second winding portion 2b is higher than the lower surface 2au of the first winding portion 2a. In this case, the heat dissipation plate 6 can be disposed on the lower surface 2bu of the second winding portion 2b. In the case where the height difference 25 is formed on each of the upper surface side and the lower surface side of the coil 2, the heat dissipation plate 6 may be disposed on each of the upper surface 2bt and the lower surface 2bu of the second winding portion 2b.

The reactor 1 according to Embodiment 1 described above is configured such that the winding portions 2a and 2b have different heights 2ah and 2bh. However, the winding portions 2a and 2b may have different widths 2aw and 2bw, the width of the second winding portion 2b may be smaller than the width of the first winding portion 2a (2aw>2bw). Even in this case, the width of the second winding portion 2b is reduced, and thus the installation space for installing the heat dissipation plate 6 can be secured accordingly. Also, both the width and the height of the second winding portion 2b may be smaller than those of the first winding portion 2a.

An interposing member (not shown) may be provided between the coil 2 and the magnetic core 3. With this configuration, the electrical insulation between the coil 2 and the magnetic core 3 can be increased. In this case, in the coil 2, the resin molded portion 2M illustrated in FIG. 3 may be omitted.

The interposing member may include, for example, an inner interposing member (not shown) interposed between the inner circumferential surface of the winding portions 2a and 2b and the outer circumferential surface of the inner core portions 31a and 31b, and an outer interposing member (not shown) interposed between the end face of the winding portions 2a and 2b and the inner end face of each outer core portion 32. The interposing member is made of an insulating material, and as the material for forming the interposing member, for example, an epoxy resin, an unsaturated polyester resin, a urethane resin, a silicone resin, a PPS resin, a PTFE resin, a liquid crystal polymer, a PA resin, a PBT resin, an ABS resin, or the like can be used.

Instead of the resin molded portion 2M described above, at least a portion of the magnetic core 3 (the inner core portions 31a and 31b and the outer core portions 32) may be molded with a resin, and a resin molded portion that covers at least a portion of the surface of the magnetic core 3 may be provided. With this configuration, the electrical insulation between the coil 2 and the magnetic core 3 (the inner core portions 31a and 31b and the outer core portions 32) can be increased. For example, the resin molded portion may be formed on the outer circumferential surfaces of the inner core portions 31a and 31b so as to prevent the inner core portions 31a and 31b from coming into contact with the inner circumferential surfaces of the winding portions 2a and 2b, or the resin molded portion may be formed on the inner end face of each outer core portion 32 so as to prevent the inner end face of the outer core portions 32 from coming into contact with the end faces of the winding portions 2a and 2b. Also, in the case where the magnetic core 3 is formed using a plurality of core pieces, by integrally molding the plurality of core pieces with a resin, the plurality of core pieces can be integrated by the resin molded portion.

In the case where the assembly 10 that includes the coil 2 and the magnetic core 3 is housed in the case 4, a sealing resin that seals the assembly 10 in the case 4 may be provided. With this configuration, the assembly 10 can be protected. As the sealing resin, for example, an epoxy resin, an unsaturated polyester resin, a urethane resin, a silicone resin, a PPS resin, a PTFE resin, a liquid crystal polymer, a PA resin, a PBT resin, an ABS resin, or the like can be used. From the viewpoint of increasing heat dissipationability, the sealing resin may be mixed with a ceramic filler that has high thermal conductivity such as alumina or silica. It is also possible to omit the case 4.

1. A reactor comprising:
a coil including a first winding portion and a second winding portion that are formed by winding a wire, the winding portions being disposed side by side; and
a magnetic core including a first inner core portion that is disposed on an inner side of the first winding portion, a second inner core portion that is disposed on an inner side of the second winding portion, and outer core portions that are disposed on an outer side of the two winding portions and connect end portions of the two inner core portions,
wherein, in the coil, a circumferential length of the second winding portion is shorter than a circumferential length of the first winding portion, and
the reactor includes a heat dissipation plate that is disposed on at least a portion of an outer circumferential surface of the second winding portion.

2. The reactor according to claim 1,
wherein, in the coil, a height of the second winding portion is smaller than a height of the first winding portion, and a height difference is formed between the first winding portion and the second winding portion, and
the heat dissipation plate is disposed on a surface of the outer circumferential surface of the second winding portion where the height difference is formed.

3. The reactor according to claim 2,
wherein a height difference portion that corresponds to the height difference of the coil is formed in the outer core portions, and
the heat dissipation plate is sized to extend to the height difference portion of the outer core portions.

4. The reactor according to claim 1, wherein the heat dissipation plate includes a fin.

5. The reactor according to claim 2, wherein the heat dissipation plate includes a fin.

6. The reactor according to claim 3, wherein the heat dissipation plate includes a fin.
